(19) United States
(12) Patent Application Publication
(10) Pub. No.: US 2024/0134784 A1
(43) Pub. Date: Apr. 25, 2024

(54) METHOD, ELECTRONIC DEVICE, AND PROGRAM PRODUCT FOR BUG CLASSIFICATION

(71) Applicant: Dell Products L.P., Round Rock, TX (US)

(72) Inventors: Jiacheng Ni, Shanghai (CN); Zijia Wang, WeiFang (CN); Bin He, Shanghai (CN); Zhen Jia, Shanghai (CN)

(21) Appl. No.: 17/985,345

(22) Filed: Nov. 11, 2022

(30) Foreign Application Priority Data
Oct. 20, 2022 (CN) 202211296062.2

(51) Int. Cl. G06F 11/36; G06N 5/02

(52) U.S. Cl. CPC G06F 11/3692; G06F 11/3608; G06N 5/022

(57) ABSTRACT

Embodiments of the present disclosure provide a method, an electronic device, and a medium for bug classification. The method includes determining, based on description information of a bug generated during product testing, classification information of the bug through at least one trained computing model; presenting the classification information of the bug; determining, based on user interaction for the presented classification information, whether performance of the at least one computing model satisfies a predetermined condition; and determining that the at least one computing model needs to be retrained in response to determining that the performance of the at least one computing model does not satisfy the predetermined condition. In this way, automatic classification of the bug is realized, and the computing model can be dynamically adjusted by retraining, so as to ensure accuracy of the automatic classification and improve efficiency of bug processing.

### RELATED APPLICATION

The present application claims priority to Chinese Patent Application No. 202211296062.2, filed Oct. 21, 2022, and entitled “Method, Electronic Device, and Program Product for Bug Classification,” which is incorporated by reference herein in its entirety.

### FIELD

Embodiments of the present disclosure relate to the field of computers, and more particularly, to a method, an electronic device, and a computer program product for bug classification.

### BACKGROUND

A computer program product is typically tested, and one or more bugs that are found may be fixed. For example, a test engineer uses test code and analyzes test results to find any bugs that may exist in the computer program product. Currently, the test engineer, after reading log information in the test results, determines a type and a cause of a given such bug based on experience, and then deals with the bug in the product. This consumes excessive amounts of time and energy of the test engineer. An effective method is needed to improve the efficiency of bug processing.

### SUMMARY

According to embodiments of the present disclosure, a solution for automatic bug classification is provided.

According to a first aspect of the present disclosure, a method for bug classification is provided. The method includes: determining, based on description information of a bug generated during product testing, classification information of the bug through at least one trained computing model; presenting the classification information of the bug; determining, based on user interaction for the presented classification information, whether performance of the at least one computing model satisfies a predetermined condition; and determining that the at least one computing model needs to be retrained in response to determining that the performance of the at least one computing model does not satisfy the predetermined condition. In this way, automatic classification of the bug generated during product testing is realized, and accuracy of the automatic classification is ensured, so as to improve efficiency of bug processing. In this way, the automatic classification of the bug is realized, and the computing model can be dynamically adjusted by retraining, so as to ensure the accuracy of the automatic classification and improve the efficiency of bug processing.

According to a second aspect of the present disclosure, an electronic device is provided, including: at least one processing unit, and at least one memory coupled to the at least one processing unit and storing instructions for execution by the at least one processing unit, where the instructions, when executed by the at least one processing unit, cause the computing device to perform a method. The method includes: determining, based on description information of a bug generated during product testing, classification information of the bug through at least one trained computing model; presenting the classification information of the bug; determining, based on user interaction for the presented classification information, whether performance of the at least one computing model satisfies a predetermined condition; and determining that the at least one computing model needs to be retrained in response to determining that the performance of the at least one computing model does not satisfy the predetermined condition.

According to a third aspect of the present disclosure, a computer program product is provided. The computer program product is tangibly stored on a non-transitory computer-readable medium and comprises machine-executable instructions, wherein the machine-executable instructions, when executed by a machine, cause the machine to perform a method according to the first aspect of the present disclosure.

### BRIEF DESCRIPTION OF THE DRAWINGS

The above and other features, advantages, and aspects of embodiments of the present disclosure will become more apparent in conjunction with the accompanying drawings and with reference to the following Detailed Description. In the accompanying drawings, identical or similar reference numerals represent identical or similar elements, in which:

FIG. 1 is a block diagram of an example environment in which some embodiments of the present disclosure may be implemented;

FIG. 2 is a block diagram of a bug management system according to an embodiment of the present disclosure;

FIG. 3 is a flow chart of a method for bug classification according to an embodiment of the present disclosure;

FIG. 4 is a flow chart of a method of predicting a bug by a computing model according to an embodiment of the present disclosure;

FIG. 5 is a schematic diagram of an example user interface (UI) for presenting classification information according to an embodiment of the present disclosure;

FIG. 6 is a flow chart of a method of determining whether performance of a computing model satisfies a predetermined condition according to an embodiment of the present disclosure; and

FIG. 7 is a block diagram of an example device that may be used to implement some embodiments according to the present disclosure.

### DETAILED DESCRIPTION

Illustrative embodiments of the present disclosure will be described in more detail below with reference to the accompanying drawings. Although the accompanying drawings show some embodiments of the present disclosure, it should be understood that the present disclosure can be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the protection scope of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

In addition, all specific numerical values in this text are examples, which are provided only to aid in understanding, and are not intended to limit the scope.

A computer program product typically needs to be tested, and a bug is fixed once found. Currently, a test engineer, after reading log information of the bug, determines a type and a cause of the bug based on experience, and then deals with the product bug. This consumes excessive amounts of time and energy of the test engineer. Various existing bug processing tools have been used to analyze the log information of a bug and classify the bug to help a test engineer improve efficiency of bug fixing. However, the tools are typically developed for general products under test and cannot provide an accurate analysis result for a particular product. On the other hand, as a program product is iteratively updated, an existing tool may be outdated and fail to provide a truly useful analysis result.

In view of the above, according to embodiments of the present disclosure, a solution for automatic bug classification is provided. In the solution, based on description information of a bug generated during product testing, classification information of the bug is determined through a trained computing model. Then, the classification information of the bug is presented to a user (for example, a test engineer). The solution further includes determining, based on user interaction for the presented classification information, whether performance of the at least one computing model satisfies a predetermined condition. If it is determined that the performance of the at least one computing model does not satisfy the predetermined condition, it is determined that the computing model needs to be retrained. In this way, according to embodiments of the present disclosure, automatic classification of the bug is realized, and the computing model can be dynamically adjusted by retraining, so as to ensure accuracy of the automatic classification and improve efficiency of bug processing.

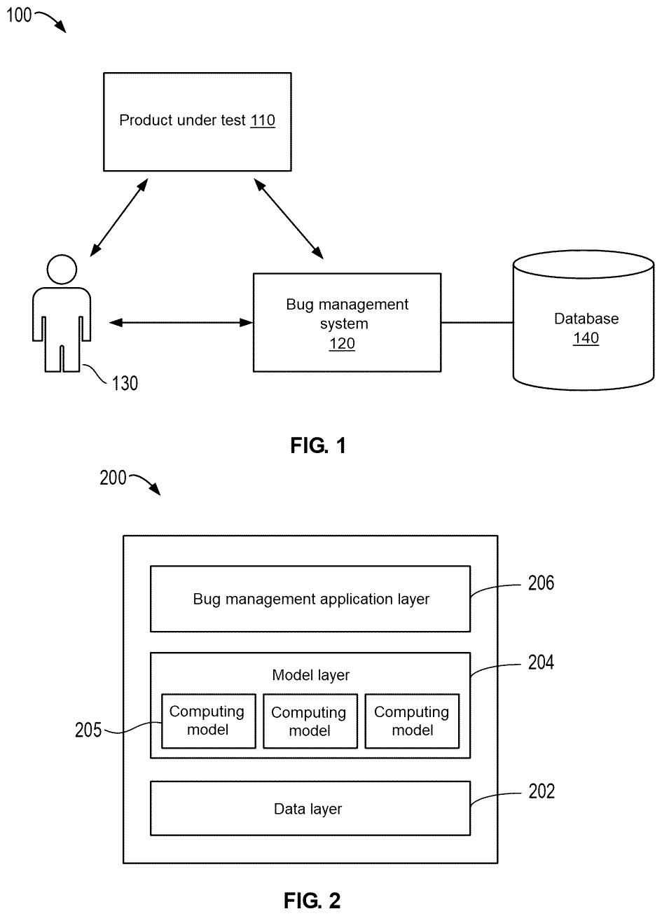

Some example embodiments of the present disclosure will be described below still with reference to FIG. 1 to FIG. 7.

FIG. 1 is a block diagram of example environment 100 according to some embodiments of the present disclosure. Example environment 100 generally depicts an exemplary computing device. Environment 100 includes product under test 110, bug management system 120, a user 130 (for example, a test engineer), and database 140. Product under test 110 may be any type of computer program in a development phase or a debugging phase. Product under test 110 may include source code written, for example, in a high-level programming language (for example, Python, Java, C++, or the like) or other types of programming languages. Product under test 110 may further include a script written in a scripting language, assembly code written in an assembly language, and the like. User 130 may use test code written manually or test code generated by a debugging tool to test product under test 110 to find and fix a bug therein.

During the testing, product under test 110 may generate a bug (for example, abnormal program termination, data loss, memory leakage, array out-of-bound, reference failure, or the like). In this case, description information (also referred to as a log) of the bug is recorded and provided to user 130. User 130 may locate the bug, trace the bug, and fix the bug according to the description information of the bug.

The description information of the bug may also be provided to bug management system 120. Bug management system 120 may analyze the description information of the bug, and give an analysis result, for example, classify the bug from product under test 110 from a plurality of aspects. For example, in bug management system 120, classification of the bug is predicted through a trained artificial intelligence (AI) based computing model. User 130 may view the analysis result through a user interface (UI) of bug management system 120. Thus, bug management system 120 provides automatic classification of the bug and reduces efforts required for the user to determine a bug category directly from the description information of the bug. It should be understood that the analysis result provided by bug management system 120 is used to assist user 130 for testing purposes, which is not necessarily accurate. User 130 may further provide feedback for the analysis result to bug management system 120, for example, to confirm, through an interactive component displayed on the UI, whether the analysis result of bug management system 120 is correct, to modify the analysis result, to add comments, and the like.

Bug management system 120 may be implemented in any device with computing power, for example, a mobile device, a desktop, a server, a large computing device, or the like, which includes, but is not limited to, a mobile phone, a multimedia computer, a multimedia tablet, a desktop computer, a laptop computer, a notebook computer, a netbook computer, a tablet computer, a cloud server, a standalone server, a server cluster, and the like.

As shown in the figure, bug management system 120 is further connected to database 140, for example, locally or remotely. Database 140 may be configured to store historical data of bugs generated during the testing. The historical data includes description information and classification information of the bugs. The classification information may be classification information confirmed by the user. For example, in response to a reporting operation of user 130, the description information and the classification information of the bugs are transmitted and stored in database 140. Therefore, the historical data of the bugs in database 140 may be considered accurate. As mentioned above, bug management system 120 may use a computing model to predict classification of the bugs. Bug management system 120 may acquire historical data of the bugs from database 140, and train the computing model by using the historical data. The classification information in the historical data may be considered as a label of the description information.

Environment 100 in which embodiments of the present disclosure can be implemented is described above with reference to FIG. 1. It should be understood that environment 100 is only an example, and embodiments of the present disclosure may also be implemented in a different environment from the environment 100. For example, product under test 110 and bug management system 120 may be implemented on the same device or on respective different devices.

FIG. 2 is a block diagram of bug management system 200 according to an embodiment of the present disclosure. Bug management system 200 may be an example specific implementation of bug management system 120 shown in FIG. 1. For ease of description, bug management system 200 in FIG. 2 is described with reference to FIG. 1.

As shown in the figure, bug management system 200 has a hierarchical structure, including data layer 202, model layer 204, and bug management application layer 206, in which model layer 204 includes a plurality of computing models 205, individually or collectively referred to herein as computing model 205. It should be understood that the number of computing models in model layer 204 is not limited to that shown in FIG. 2, and more or fewer computing models may be used.

Data layer 202 is configured to acquire historical data of a bug from database 140 to train computing model 205 in model layer 204. The data layer may be further configured to acquire description information of a bug generated during the testing from product under test 110, encode the description information into a feature matching the computing model, and provide the feature to trained computing model 205 in model layer 204.

Computing model 205 in model layer 204 may be an AI model, for example, an eXtreme Gradient Boosting (XGBoost) model, a deep learning model, or the like. Computing model 205, after training, may receive a feature in a supported format, and generate a predicted classification result. As an example, in a case where computing model 205 is an XGBoost model, the description information may be encoded into a feature in an LIBSVM format by one-hot encoding, where LIBSVM denotes a well-known machine learning library for support vector machines. In some embodiments, computing model 205 may be a binary classification model for binary classification of an aspect of a bug, for example, whether the bug is a bug that needs to be fixed, whether the bug is caused by software or hardware, whether the bug is a bug in a product under test or a bug in test code, and the like.

Bug management application layer 206 may include an application (not shown) deployed in bug management system 200, such as a project management application (JIRA™). Bug management application layer 206 is used as an interface between user 130 and other components in bug management system 200. Specifically, bug management application layer 206 may receive a predicted classification result from model layer 204 and present the classification result to user 130 through a UI (not shown), so as to help user 130 understand and fix the bug. Bug management application layer 206 may further receive user interaction of user 130 for the classification result through the UI, for example, to confirm the classification result or to modify the classification result, to input comments on the bug, and the like. Such information from user 130 may be used to determine performance of computing model 205 so as to determine whether the performance of computing model 205 satisfies a condition. If the performance of computing model 205 does not satisfy the condition, computing model 205 may be retrained.

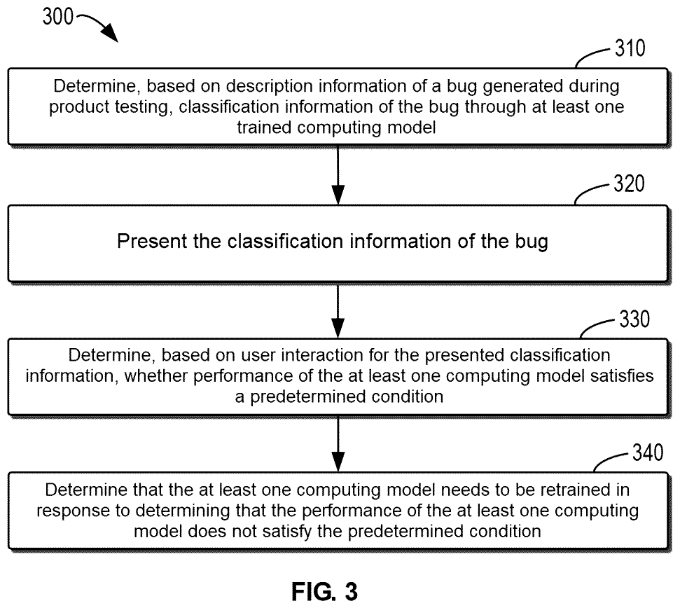

FIG. 3 is a flow chart of method 300 for bug classification according to an embodiment of the present disclosure. Method 300 may be implemented at bug management system 120 shown in FIG. 1 and bug management system 200 shown in FIG. 2. It should be understood that method 300 may also include additional actions not shown and/or may omit actions shown, and the scope of the present disclosure is not limited in this regard. For ease of understanding, method 300 will be described with reference to FIG. 1 and FIG. 2.

At block 310, based on description information of a bug generated during product testing, classification information of the bug is determined through at least one trained computing model 205 in model layer 204. In some embodiments, product under test 110 generates a bug when tested by user 130. The bug includes description information. The description information is transmitted to data layer 202. Then, the description information is encoded into a feature through data layer 202, which is fed to computing model 205 in model layer 204 for automatic classification.

As indicated previously, computing model 205 may include a plurality of computing models, and in some embodiments each such model may be configured to classify a different aspect of the bug. In some embodiments, the plurality of computing models may include a first computing model, a second computing model, and a third computing model. The first computing model is configured to determine whether the bug needs to be fixed. The second computing model is configured to determine whether the bug is a software bug or a hardware bug. The software bug refers to a bug caused by code, while the hardware bug refers to a bug caused by a hardware factor in a test environment. The third computing model is configured to determine whether the bug is a product code bug of product under test 110 or a test code bug of user 130.

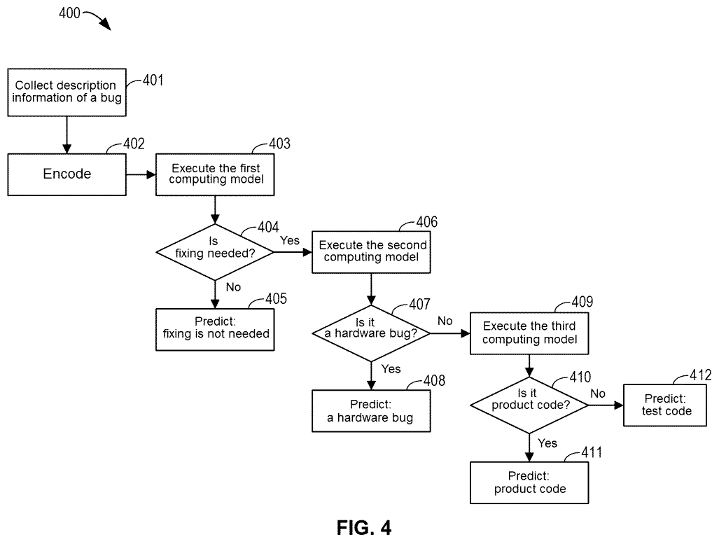

Classification tasks of the above computing models may be performed in a predefined order, and a classification task of a subsequent computing model may be determined according to a classification result of a previous computing model, which can save computing resources and improve a running speed of automatic bug classification. An example classification process is described with reference to FIG. 4.

FIG. 4 is a flow diagram of a method 400 of predicting a bug by a computing model according to an embodiment of the present disclosure. At block 401, description information of a bug is collected. For example, the description information of the bug may be acquired from product under test 110 through data layer 202. At block 402, the description information is encoded to obtain a feature of the bug.

Then, at block 403, the feature of the bug is provided to the first computing model, and the first computing model is executed to predict whether the bug needs to be fixed. If it is determined at block 404 that the bug is not a bug that needs to be fixed, method 400 proceeds to block 405 to generate a prediction result that fixing is not needed. In this case, prediction of the second computing model and the third computing model may not be performed.

If it is determined at block 404 that the bug is a bug that needs to be fixed, method 400 proceeds to block 406 to provide the feature of the bug to the second computing model, and the second computing model is executed to predict whether the bug is a software bug or a hardware bug. If it is determined at block 407 that the bug is a hardware bug, method 400 proceeds to block 408 to generate a prediction result that the bug is a hardware bug. In this case, prediction of the third computing model may not be performed.

If it is determined at block 407 that the bug is a software bug, method 400 proceeds to block 409 to provide the feature of the bug to the third computing model, and the third computing model is executed to predict whether the bug is a bug in product code or a bug in test code. If it is determined at block 410 that the bug is a bug in product code, method 400 proceeds to block 411 to generate a prediction that the bug is a bug in product code. Otherwise, the method proceeds to block 412 to generate a prediction that the bug is a bug in test code. The prediction results of the first, second, and third computing models can be integrated to form a classification result of the bug.

It needs to be noted that any computing model may generate a degree of confidence for predicted classification, and determine a prediction result according to a decision-making threshold. When a degree of confidence of a specified category is greater than a corresponding decision-making threshold, a binary classification computing model determines the prediction result to be the category. It should be understood that a pending prediction result may be generated if a degree of confidence of any category does not reach the decision-making threshold thereof. In this case, other computing models are continued to be executed. The decision-making thresholds for the computing models may be different and may be adjusted.

Referring back to FIG. 3, at block 320, the classification information of the bug is presented. A classification result generated by computing model 205 in model layer 204 may be provided to bug management application layer 206 so as to present the classification result to user 130 through a UI.

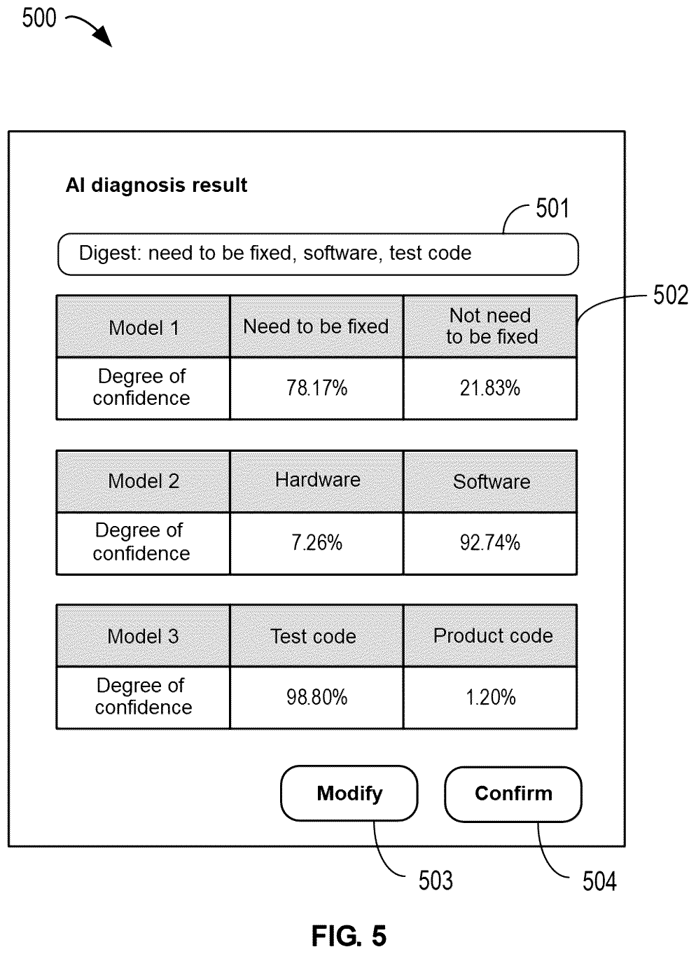

FIG. 5 is a schematic diagram of example UI 500 for presenting classification information according to an embodiment of the present disclosure. In UI 500, classification result 501 generated by the three example computing models is shown as an AI diagnosis result: A classification result determined by the first computing model is “need to be fixed,” a classification result determined by the second computing model is “software,” and a classification result determined by the third computing model is “test code.” Degree of confidence 502 for each category generated by each computing model is further shown in UI 500. By use of such information, user 130 can quickly learn predicted classification of the bug without the need to read and understand more complex description information.

Referring again to FIG. 3, at block 330, it is determined, based on user interaction for the presented classification information, whether performance of the at least one computing model satisfies a predetermined condition. User 130 may determine whether the classification information given by the computing model is accurate in combination with the description information and other information of the bug by using his/her own skills. If user 130 determines that the classification information is accurate, user 130 may make confirmation through interactive component 504 in UI 500. If user 130 determines that the classification information is not accurate, user 130 may modify the classification information through interactive component 503. It should be understood that UI 500 is only an example, and the user interaction may occur anywhere in the UI and is not limited to the example interactive components in example UI 500 shown in FIG. 5.

The presented classification information may be modified based on user interaction and then modified classification information and the description information of the bug are stored, for example, in database 140, which are used as training data for training computing model 205 later. The modified classification information is used as an annotation of the description information. After a certain period of time has elapsed or accumulated bugs have reached a certain number, the computing model may be retrained using the description information of the bugs and the modified classification information.

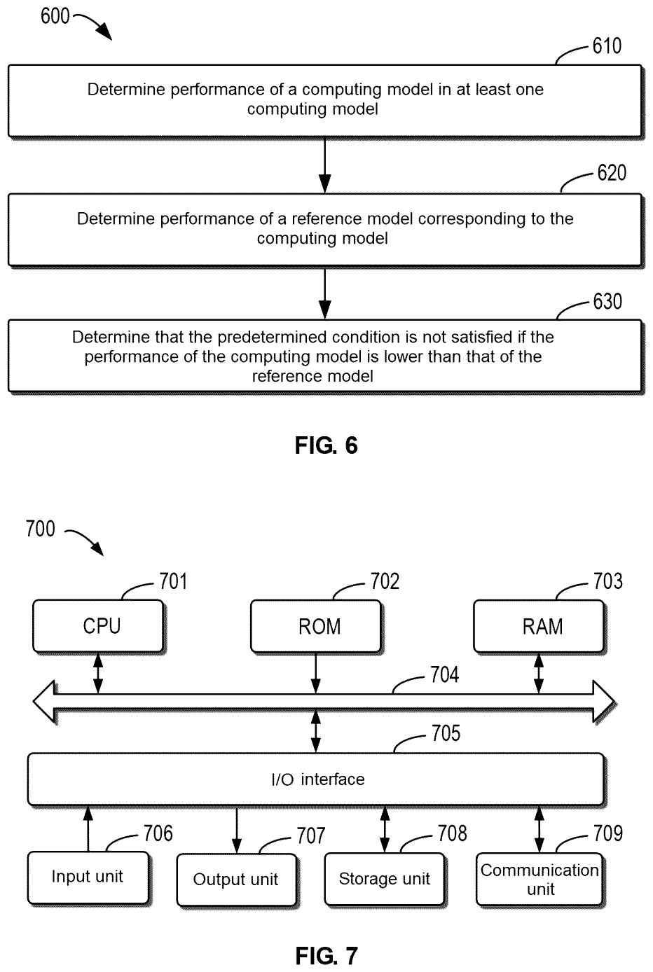

User interaction from user 130 provides a real benchmark for the bug, so performance of the model can be determined using the user interaction, and then it is determined whether the performance of computing model 205 satisfies a predetermined condition. In some embodiments, the predetermined condition may be whether accuracy of the computing model reaches a target threshold. In some embodiments, the predetermined condition may be a result of comparison between performance of computing model 205 and another model. Description is given with reference to FIG. 6.

FIG. 6 is a flow chart of a method 600 of determining whether performance of a computing model satisfies a predetermined condition according to an embodiment of the present disclosure. At block 610, performance of a computing model in at least one computing model is determined. Herein, the computing model may be, for example, any computing model 205 shown in FIG. 2, for example, the first computing model, the second computing model, or the third computing model mentioned above. The performance may indicate accuracy of a computing model, expressed, for example, by an area under the curve (AUC) metric. The performance may also be expressed by other indexes, which is not limited in embodiments of the present disclosure.

In some embodiments, determining performance of a computing model may include determining a real benchmark for classification of the bug based on the user interaction, and determining the performance of the computing model based on classification information determined by the computing model and the real benchmark. For example, accuracy of a computing model (such as a binary classification model) for a batch of bugs may be determined based on the real benchmark and predicted classification information of the computing model. For example, an AUC value of the computing model may be determined by a false positive rate, a true positive rate, a false negative rate, a true negative rate, and the like.

At block 620, performance of a reference model corresponding to the computing model is determined. The reference model is configured to perform the same classification task as the computing model and may be trained using the same training data. For example, the first computing model is configured to predict whether the bug needs to be fixed, and then a corresponding reference model exists to be also configured to predict whether the bug needs to be fixed. The second computing model is configured to predict whether the bug is a software bug or a hardware bug, and then a corresponding reference model exists to be also configured to predict whether the bug is a software bug or a hardware bug. The third computing model is configured to predict whether the bug is a product cost bug or a test code bug, and then a corresponding reference model exists to be also configured to predict whether the bug is a product cost bug or a test code bug.

In some embodiments, with reference to block 310 of FIG. 3, when the computing model determines the classification information based on the description information of the bug, the corresponding reference model also determines the classification information based on the bug. However, classification information generated by the reference model may not be presented to user 130 but is temporarily saved in order to determine performance thereof in conjunction with the classification information used as a real benchmark.

The reference model may have fewer parameters than the computing model, and therefore is easier to train and has better stability. For example, the reference model may be a logistic regression (LR) model. Performance of the reference model may be determined in the same manner as the computing model. Generally, the reference model has lower performance or accuracy than the corresponding computing model.

Next, at block 630, if the performance of the computing model is lower than that of the reference model, it is determined that the performance of the computing model does not satisfy the predetermined condition.

Referring back to FIG. 3, at block 340, it is determined that the at least one computing model needs to be retrained in response to determining that the performance of the at least one computing model does not satisfy the predetermined condition. As mentioned above, the computing model generally has better performance than the reference model. However, when the opposite is detected, it means that the current computing model may no longer be suitable to give the user the classification information predicted by the computing model. In this case, the use of the computing model may be suspended, or user 130 may be prompted to do so, or user 130 may be advised to retrain the computing model at an appropriate time. In this way, method 300 in FIG. 3 realizes the automatic classification of the bug, and can dynamically adjust the computing model by retraining, so as to ensure the accuracy of the automatic classification and improve the efficiency of bug processing.

Reasons for degradation of the performance of the computing model may be diverse. In an example case, a product being tested by the user is a new-version product. In this case, adjustment for the computing model may also be initiated proactively. In some embodiments, a decision-making threshold of a degree of confidence for the computing model to classify the bug may be increased. In other words, only a bug that meets a higher decision-making threshold can be classified into a corresponding category. That is, more stringent classification is performed. The classification information of the bug may also be presented in a highlighted manner in response to the degree of confidence for the computing model to classify the bug being lower than a predetermined threshold. The user is reminded in this manner that the classification information currently given by the computing model may not be accurate enough. In addition, retraining may also be proactively initiated at an appropriate time to retrain the computing model by using training data of a bug in the new-version product. Based on such techniques, the accuracy of the automatic classification is ensured, and the efficiency of bug processing is improved.

FIG. 7 is a block diagram of example device 700 that may be used to implement some embodiments according to the present disclosure. As shown FIG. 7, device 700 includes central processing unit (CPU) 701, which may execute various appropriate actions and processing in accordance with computer program instructions stored in read-only memory (ROM) 702 or computer program instructions loaded from storage unit 708 onto random access memory (RAM) 703. Various programs and data required for the operation of device 700 may also be stored in RAM 703. CPU 701, ROM 702, and RAM 703 are connected to each other through bus 704. Input/Output (I/O) interface 705 is also connected to bus 704.

A plurality of components in device 700 are connected to I/O interface 705, including: input unit 706, such as a keyboard and a mouse; output unit 707, such as various types of displays and speakers; storage unit 708, such as a magnetic disk and an optical disc; and communication unit 709, such as a network card, a modem, and a wireless communication transceiver. Communication unit 709 allows device 700 to exchange information/data with other devices via a computer network such as the Internet and/or various telecommunication networks.

The individual processes and processing described above, such as methods or processes 300, 400, and 600, can be performed by CPU 701. For example, in some embodiments, methods or processes 300, 400, and 600 may be implemented as a computer software program that is tangibly included in a machine-readable medium such as storage unit 708. In some embodiments, part or all of the computer program may be loaded and/or installed onto device 700 via ROM 702 and/or communication unit 709. One or more actions of methods or processes 300, 400, and 600 described above may be performed when the computer program is loaded into RAM 703 and executed by CPU 701.

Embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or a plurality of programming languages, the programming languages including object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, the apparatus (system), and the computer program product according to embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or a plurality of blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or a plurality of executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms used herein is intended to best explain the principles and practical applications of the various embodiments and their associated improvements, so as to enable persons of ordinary skill in the art to understand the embodiments disclosed herein.

What is claimed is:

1. A method for bug classification, comprising:
determining, based on description information of a bug generated during product testing, classification information of the bug through at least one trained computing model;
presenting the classification information of the bug;
determining, based on user interaction for the presented classification information, whether performance of the at least one computing model satisfies a predetermined condition; and
determining that the at least one computing model needs to be retrained in response to determining that the performance of the at least one computing model does not satisfy the predetermined condition.

2. The method according to claim 1, wherein determining whether performance of the at least one computing model satisfies a predetermined condition comprises:
determining performance of a computing model in the at least one computing model based on the user interaction;
determining performance of a reference model corresponding to the computing model, the reference model having fewer parameters than the computing model; and
determining that the predetermined condition is not satisfied in response to the performance of the computing model being lower than that of the reference model.

3. The method according to claim 2, wherein determining performance of a computing model in the at least one computing model comprises:
determining a real benchmark for classification of the bug based on the user interaction; and
determining the performance of the computing model based on classification information determined by the computing model and the real benchmark.

4. The method according to claim 1, wherein the at least one computing model comprises at least one of the following:
a first computing model configured to determine whether the bug needs to be fixed;
a second computing model configured to determine whether the bug is a software bug or a hardware bug; and
a third computing model configured to determine whether the bug is a product code bug or a test code bug.

5. The method according to claim 4, wherein determining classification information of the bug through at least one trained computing model comprises:
determining, through the first computing model, whether the bug needs to be fixed;
determining, through the second computing model, whether the bug is a software bug or a hardware bug in response to determining that the bug needs to be fixed; and
determining, through the third computing model, whether the bug is a product code bug or a test code bug in response to determining that the bug is a software bug.

6. The method according to claim 1, further comprising:
modifying the presented classification information based on the user interaction; and
storing the modified classification information and the description information of the bug for retraining of the at least one computing model, the modified classification information being used as an annotation of the description information.

7. The method according to claim 1, wherein the product is a new-version product, and the method further comprises:
increasing a decision-making threshold of a degree of confidence for the at least one computing model to classify the bug; and/or
presenting the classification information of the bug in a highlighted manner in response to the degree of confidence for the at least one computing model to classify the bug being lower than a predetermined threshold; and/or
retraining the at least one computing model by using training data related to a bug in the new-version product.

8. An electronic device, comprising:
at least one processing unit; and
at least one memory coupled to the at least one processing unit and storing instructions for execution by the at least one processing unit, wherein the instructions, when executed by the at least one processing unit, cause the electronic device to perform a method comprising:
determining, based on description information of a bug generated during product testing, classification information of the bug through at least one trained computing model;
presenting the classification information of the bug;
determining, based on user interaction for the presented classification information, whether performance of the at least one computing model satisfies a predetermined condition; and
determining that the at least one computing model needs to be retrained in response to determining that the performance of the at least one computing model does not satisfy the predetermined condition.

9. The electronic device according to claim 8, wherein determining whether performance of the at least one computing model satisfies a predetermined condition comprises:
determining performance of a computing model in the at least one computing model based on the user interaction;
determining performance of a reference model corresponding to the computing model, the reference model having fewer parameters than the computing model; and
determining that the predetermined condition is not satisfied in response to the performance of the computing model being lower than that of the reference model.

10. The electronic device according to claim 9, wherein determining performance of a computing model in the at least one computing model comprises:
determining a real benchmark for classification of the bug based on the user interaction; and
determining the performance of the computing model based on classification information determined by the computing model and the real benchmark.

11. The electronic device according to claim 8, wherein the at least one computing model comprises at least one of the following:
a first computing model configured to determine whether the bug needs to be fixed;
a second computing model configured to determine whether the bug is a software bug or a hardware bug; and
a third computing model configured to determine whether the bug is a product code bug or a test code bug.

12. The electronic device according to claim 11, wherein determining classification information of the bug through at least one trained computing model comprises:
determining, through the first computing model, whether the bug needs to be fixed;
determining, through the second computing model, whether the bug is a software bug or a hardware bug in response to determining that the bug needs to be fixed; and
determining, through the third computing model, whether the bug is a product code bug or a test code bug in response to determining that the bug is a software bug.

13. The electronic device according to claim 8, further comprising:
modifying the presented classification information based on the user interaction; and
storing the modified classification information and the description information of the bug for retraining of the at least one computing model, the modified classification information being used as an annotation of the description information.

14. The electronic device according to claim 8, wherein the product is a new-version product, and the method further comprises:
increasing a decision-making threshold of a degree of confidence for the at least one computing model to classify the bug; and/or
presenting the classification information of the bug in a highlighted manner in response to the degree of confidence for the at least one computing model to classify the bug being lower than a predetermined threshold; and/or
retraining the at least one computing model by using training data related to a bug in the new-version product.

15. A computer program product tangibly stored on a non-transitory computer-readable medium and comprising machine-executable instructions, wherein the machine-executable instructions, when executed by a machine, cause the machine to perform a method comprising:
determining, based on description information of a bug generated during product testing, classification information of the bug through at least one trained computing model;
presenting the classification information of the bug;
determining, based on user interaction for the presented classification information, whether performance of the at least one computing model satisfies a predetermined condition; and
determining that the at least one computing model needs to be retrained in response to determining that the performance of the at least one computing model does not satisfy the predetermined condition.

16. The computer program product according to claim 15, wherein determining whether performance of the at least one computing model satisfies a predetermined condition comprises:
determining performance of a computing model in the at least one computing model based on the user interaction;
determining performance of a reference model corresponding to the computing model, the reference model having fewer parameters than the computing model; and
determining that the predetermined condition is not satisfied in response to the performance of the computing model being lower than that of the reference model.

17. The computer program product according to claim 16, wherein determining performance of a computing model in the at least one computing model comprises:
determining a real benchmark for classification of the bug based on the user interaction; and
determining the performance of the computing model based on classification information determined by the computing model and the real benchmark.

18. The computer program product according to claim 15, wherein the at least one computing model comprises at least one of the following:
a first computing model configured to determine whether the bug needs to be fixed;
a second computing model configured to determine whether the bug is a software bug or a hardware bug; and
a third computing model configured to determine whether the bug is a product code bug or a test code bug.

19. The computer program product according to claim 18, wherein determining classification information of the bug through at least one trained computing model comprises:
determining, through the first computing model, whether the bug needs to be fixed;
determining, through the second computing model, whether the bug is a software bug or a hardware bug in response to determining that the bug needs to be fixed; and
determining, through the third computing model, whether the bug is a product code bug or a test code bug in response to determining that the bug is a software bug.

20. The computer program product according to claim 15, wherein the method further comprises:
modifying the presented classification information based on the user interaction; and
storing the modified classification information and the description information of the bug for retraining of the at least one computing model, the modified classification information being used as an annotation of the description information.
